(19) United States
(12) Patent Application Publication
(10) Pub. No.: US 2022/0126387 A1
(43) Pub. Date: Apr. 28, 2022

(54) BRAZING METHOD AND BRAZING APPRATUS

(71) Applicant: HONDA MOTOR CO., LTD., Minato-ku, Tokyo (JP)

(72) Inventors: Tokuji Okumura, Haga-gun, Tochigi-ken (JP); Mitsugu Kaneko, Haga-gun, Tochigi-ken (JP); Hiroki Fujiuchi, Haga-gun, Tochigi-ken (JP); Akira Goto, Haga-gun, Tochigi-ken (JP); Hitoshi Arai, Haga-gun, Tochigi-ken (JP)

(21) Appl. No.: 17/437,438

(22) PCT Filed: Jan. 7, 2020
(86) PCT No.: PCT/JP2020/000154

§ 371 Date: Sep. 9, 2021

(30) Foreign Application Priority Data
Mar. 13, 2019 (JP) 2019-045316

(51) Int. Cl. B23K 1/005; B23K 26/08; B23K 26/14; B23K 3/08

(52) U.S. Cl. CPC B23K 1/0056; B23K 26/0869; B23K 2101/006; B23K 3/08; B23K 26/1464

(57) ABSTRACT

The present invention pertains to a brazing method and a brazing apparatus. This brazing method comprises: a brazing material supply step for supplying a brazing material to a to-be-welded part; and a laser irradiation step for irradiating the brazing material having been supplied to the to-be-welded part with a laser beam while moving the laser beam along a brazing direction to form a welding bead. In the laser irradiation step, a gas is injected toward an area to be injected with gas, which is an area encompassing the welding bead located rearward of a laser-irradiated portion of the brazing material in the brazing direction, from above said area or from a front side of said area in the brazing direction.

### TECHNICAL FIELD

The present invention relates to a brazing method and a brazing apparatus for joining workpieces together by forming a weld bead at welded portions of the workpieces by melting and then solidifying a brazing material.

### BACKGROUND ART

For example, a brazing method disclosed in JP 2514150 B2 is known. In this brazing method, a brazing material is melted and then solidified to form a weld bead at welded portions of workpieces, thereby joining the workpieces together. Specifically, the brazing material supplied to the welded portions of the workpieces is irradiated with a laser beam while the laser beam is moved along the brazing advancing direction. The welded portions are wetted with the brazing material thus melted, and then the brazing material is cooled and solidified. As a result, a weld bead is formed at the welded portions, and the workpieces are joined together via the weld bead.

In this type of brazing method, a gas may be supplied toward the workpieces in order to promote solidification of the brazing material by cooling the melted brazing material. In the brazing method disclosed in JP 2514150 B2, a gas injection port is disposed so as to be adjacent to a laser irradiation port along a direction orthogonal to the brazing advancing direction (hereinafter, also simply referred to as an orthogonal direction), and the gas is injected from the injection port in parallel with the irradiation direction of the laser beam.

### SUMMARY OF INVENTION

Meanwhile, for example, in a case where a roof panel and a side panel constituting a vehicle body are used as workpieces and a joined body is obtained by forming a joining bead on outer surface sides of the panels, the surface shape of the weld bead affects the appearance of the joined body. For this reason, if the weld bead is formed in a state in which spatters and fumes generated from the brazing material at the time of laser irradiation are deposited, and an extra operation of scraping off the spatters and fumes deposited on the weld bead is necessary.

Therefore, it is required to suppress formation of a weld bead on which spatters and fumes are deposited. However, even if the gas is injected in parallel with the laser irradiation direction from the gas injection port arranged as described above, it is difficult to suppress formation of a weld bead on which spatters and fumes are deposited.

In addition, when the brazing material and the welded portions before laser irradiation are cooled by the gas injected as described above, there is a concern that the melting efficiency of the brazing material decreases and the wettability of the welded portions decreases. As a result, there arises a concern that it is difficult to efficiently or satisfactorily join the workpieces together via the weld bead.

The present invention has been made in view of the above-described problems, and an object of the present invention is to provide a brazing method and a brazing apparatus capable of suppressing formation of a weld bead on which spatters and fumes are deposited and efficiently and satisfactorily joining workpieces together.

According to an aspect of the present invention, there is provided a brazing method for joining together workpieces by forming a weld bead at welded portions of the workpieces by melting and then solidifying a brazing material, the brazing method comprising: a brazing material supply step of supplying the brazing material to the welded portions; and a laser irradiation step of irradiating the brazing material supplied to the welded portions with a laser beam while moving the laser beam along a brazing advancing direction to form the weld bead, wherein in the laser irradiation step, gas is injected toward a gas injection target portion from above the gas injection target portion or from a front side of the gas injection target portion in the brazing advancing direction, the gas injection target portion being a portion including the weld bead located on a rear side, in the brazing advancing direction, of a laser irradiation portion of the brazing material that is irradiated with the laser beam.

According to another aspect of the present invention, there is provided a brazing apparatus that joins workpieces together by forming a weld bead at welded portions of the workpieces by melting and then solidifying a brazing material, the brazing apparatus comprising: a brazing material supply mechanism configured to supply the brazing material to the welded portions; a laser irradiation mechanism configured to irradiate the brazing material supplied to the welded portions with a laser beam; a transport mechanism configured to move the brazing material supply mechanism and the laser irradiation mechanism in a brazing advancing direction relative to the welded portions; and a gas injection mechanism configured to inject gas toward a gas injection target portion from above the gas injection target portion or from a front side of the gas injection target portion in the brazing advancing direction, the gas injection target portion being a portion including the weld bead located on a rear side, in the brazing advancing direction, of a laser irradiation portion of the brazing material that is irradiated with the laser beam by the laser irradiation mechanism.

In the present invention, the gas is injected toward the gas injection target portion from above the gas injection target portion or from the front side of the gas injection target portion in the brazing advancing direction. In this case, the peak of the flow velocity or flow rate of the gas flowing along the workpieces can be generated behind the laser irradiation portion in the brazing advancing direction. By dispersing the spatters and fumes by this gas, it is possible to suppress the spatters and fumes from being deposited on the melted brazing material generated behind the laser irradiation portion in the brazing advancing direction. As a result, formation of a weld bead on which spatters and fumes are deposited can be suppressed.

In addition, by injecting the gas in a manner described above, it is possible to suppress cooling, with the gas, of the brazing material and the welded portions before laser irradiation, which are located ahead of the laser irradiation mechanism in the brazing advancing direction. In this case, since the brazing material is not cooled, the brazing material irradiated with the laser beam can be rapidly melted. Further, since the welded portions are not cooled, the welded portions can be easily wetted with the melted brazing material. As a result, it is possible to efficiently or satisfactorily join the workpieces together via the weld bead.

As described above, according to the present invention, it is possible to suppress formation of a weld bead on which spatters and fumes are deposited, and it is also possible to efficiently and satisfactorily join workpieces together.

### BRIEF DESCRIPTION OF DRAWINGS

FIG. 1 is a schematic perspective view of a brazing apparatus according to an embodiment of the present invention and workpieces;

FIG. 2 is an enlarged explanatory view of a main part of the brazing apparatus of FIG. 1;

FIG. 3 is an enlarged explanatory view of a main part of a brazing apparatus according to a modified example; and

FIG. 4 is an enlarged explanatory view of a main part of a brazing apparatus according to another modified example.

### DESCRIPTION OF EMBODIMENTS

Preferred embodiments of a brazing method and a brazing apparatus according to the present invention will be described in detail with reference to the accompanying drawings. In the following drawings, components having the same or similar functions and effects are denoted by the same reference numerals, and repeated description thereof may be omitted.

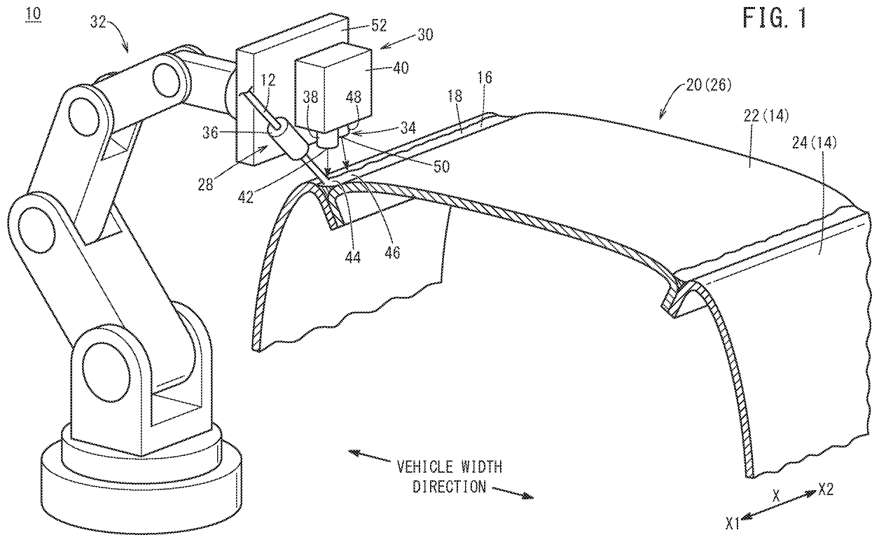

As shown in FIG. 1, a brazing apparatus 10 according to the present embodiment melts and then solidifies a brazing material 12 to form a weld bead 18 at welded portions 16 of workpieces 14, thereby joining the workpieces 14 together. The brazing apparatus 10 can be particularly suitably applied to the case of joining the workpieces 14 in which the surface shape of the weld bead 18 affects the appearance of a joined body 26. As a specific example, a roof panel 22 and a side panel 24 constituting a vehicle body 20 are used as the workpieces 14, and the weld bead 18 is formed on the outer surface sides of the workpieces 14 to obtain the joined body 26.

Therefore, in the embodiment described below, an example case will be described in which the roof panel 22 and the side panel 24 are used as the workpieces 14, and the brazing apparatus 10 is used to form the weld bead 18 at the welded portions 16 disposed at both end portions of the outer surface side of the roof panel 22 in the vehicle width direction so as to extend in the front-rear direction (the direction of arrow X) of the vehicle body 20. However, the present invention is not particularly limited thereto, and the brazing apparatus 10 according to the present invention can be applied to the case of brazing various workpieces.

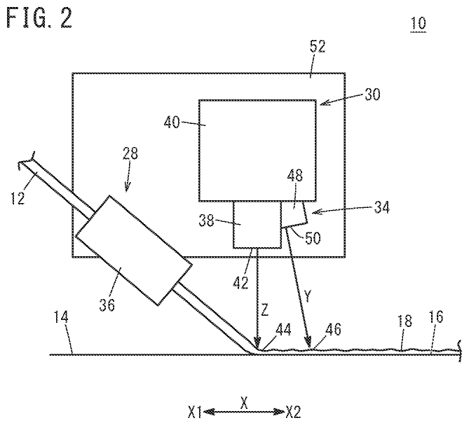

As shown in FIGS. 1 and 2, the brazing apparatus 10 mainly includes a brazing material supply mechanism 28, a laser irradiation mechanism 30, a transport mechanism 32, and a gas injection mechanism 34. The brazing material supply mechanism 28 supplies the wire-shaped brazing material 12 fed from a reel section (not shown), to the welded portions 16 of the workpieces 14 via a guide section 36.

The laser irradiation mechanism 30 includes a laser oscillator (not shown), an irradiation nozzle 38 connected to the laser oscillator via a transmission cable (not shown) or the like, and a holding section 40 that holds the irradiation nozzle 38. The laser irradiation mechanism 30 irradiates the brazing material 12 supplied to the welded portions 16 of the workpieces 14 with a laser beam. Specifically, a laser beam oscillated by the laser oscillator is irradiated toward the brazing material 12 from an irradiation port 42 provided at the tip of the irradiation nozzle 38. The brazing material 12 heated by being irradiated with the laser beam is melted to wet the welded portions 16, and is then cooled and solidified to form the weld bead 18.

The gas injection mechanism 34 injects gas toward a portion (hereinafter also referred to as a “gas irradiation target portion 46”) including the weld bead 18 located on the rear side (the arrow X2 side), in the brazing advancing direction, of a laser irradiation portion 44 of the brazing material 12 that is irradiated with the laser beam by the laser irradiation mechanism 30. Specifically, the gas injection mechanism 34 includes an injection nozzle 48 to which compressed gas is supplied from a gas source (not shown), and injects the gas toward the gas injection target portion 46 from an injection port 50 provided at the tip of the injection nozzle 48. Examples of the gas injected by the gas injection mechanism 34 include dry air and argon gas.

In the present embodiment, the injection nozzle 48 of the gas injection mechanism 34 is held by the holding section 40 of the laser irradiation mechanism 30. The injection port 50 of the injection nozzle 48 is arranged behind the irradiation port 42 of the irradiation nozzle 38 in the brazing advancing direction. The gas injection mechanism 34 injects gas toward the gas injection target portion 46 from the front side (arrow X1 side) of the gas injection target portion 46 in the brazing advancing direction. That is, the gas injection mechanism 34 injects the gas from the front side (arrow X1 side) toward the rear side (arrow X2 side) in the brazing advancing direction so that the gas injection direction Y (see FIG. 2) is inclined with respect to the laser irradiation direction Z (see FIG. 2).

The transport mechanism 32 is formed of, for example, an articulated robot, and the guide section 36 of the brazing material supply mechanism 28 and the holding section 40 of the laser irradiation mechanism 30 are supported by a support frame 52 provided at the distal end of the articulated robot. Therefore, by moving the support frame 52, the transport mechanism 32 can integrally move the guide section 36, the irradiation nozzle 38, and the injection nozzle 48 along the brazing advancing direction, relative to the welded portions 16. Note that the transport mechanism 32 has a general configuration capable of three dimensionally moving the support frame 52 in the brazing advancing direction and in directions approaching and separating from the welded portions 16 of the workpieces 14. Therefore, detailed description of the transport mechanism 32 is omitted.

The brazing apparatus 10 according to the present embodiment is basically configured as described above. Next, the brazing method according to the present embodiment will be described by taking, as an example, a case where the roof panel 22 and the side panel 24 are joined together by forming the weld bead 18 at the welded portions 16 using the brazing apparatus 10.

In this brazing method, first, a brazing material supply step of supplying the brazing material 12 to the welded portions 16 is performed. The brazing material 12 and the welded portions 16 are preferably preheated in order to facilitate melting of the brazing material 12 and wetting of the welded portions 16 with the melted brazing material 12.

Next, a laser irradiation step is performed. In the laser irradiation step, the brazing material 12 supplied to the welded portions 16 is irradiated with the laser beam while the laser beam is moved along the brazing advancing direction. As a result, the weld bead 18 is formed. That is, the brazing material 12 heated by the laser irradiation is melted to wet the welded portions 16, and is then solidified by being cooled. As a result, the weld bead 18 is formed at the welded portions 16. Spatters or fumes may be generated from the brazing material 12 irradiated with the laser beam.

In the laser irradiation step, gas is injected toward the gas injection target portion 46 from the front side of the gas injection target portion 46 in the brazing advancing direction. That is, the gas is injected from the front side toward the rear side in the brazing advancing direction so that the gas injection direction Y is inclined with respect to the laser irradiation direction Z. Further, the gas is injected from the gas injection port 50 arranged behind the laser irradiation port 42 in the brazing advancing direction.

By injecting the gas toward the gas injection target portion 46 as described above, the peak of the flow velocity or flow rate of the gas flowing along the workpieces 14 can be generated behind the laser irradiation portion 44 in the brazing advancing direction. By dispersing the spatters and fumes by this gas, it is possible to suppress the spatters and fumes from being deposited on the melted brazing material 12 generated behind the laser irradiation portion 44 in the brazing advancing direction. As a result, it is possible to suppress the formation of the weld bead 18 on which spatters and fumes are deposited.

In addition, by injecting the gas as described above, it is possible to suppress cooling, with the gas, of the brazing material 12 and the welded portions 16 before the laser irradiation, which are located ahead of the laser irradiation mechanism 30 in the brazing advancing direction. In this case, since the brazing material 12 is not cooled, it is possible to rapidly melt the brazing material 12 irradiated with the laser beam. Further, since the welded portions 16 are not cooled, it is possible to easily wet the welded portions 16 with the melted brazing material 12. As a result, it is possible to efficiently and satisfactorily join the workpieces 14 via the weld bead 18.

As described above, with the brazing apparatus 10 and the brazing method according to the present embodiment, it is possible to suppress the formation of the weld bead 18 on which spatters and fumes are deposited, and to efficiently and satisfactorily join the workpieces 14 together. Therefore, even if brazing is performed, it is possible to suppress deterioration of the aesthetic design of the joined body 26 (see FIG. 1), and to suppress the occurrence of an extra operation of scraping off spatters and fumes deposited on the weld bead 18.

In the laser irradiation step of the brazing method according to the above-described embodiment, the gas is injected from the front side toward the rear side in the brazing advancing direction so that the gas injection direction Y is inclined with respect to the laser irradiation direction Z. Further, in the brazing apparatus 10 according to the above-described embodiment, the gas injection mechanism 34 injects the gas from the front side toward the rear side in the brazing advancing direction so that the gas injection direction Y is inclined with respect to the laser irradiation direction Z.

In these cases, by injecting the gas as described above, it is possible to effectively form, on the workpieces 14, a gas flow from the front side toward the rear side in the brazing advancing direction. Therefore, the spatters and fumes can be satisfactorily dispersed away from the melted brazing material 12. As a result, it is possible to more effectively suppress the formation of the weld bead 18 on which spatters and fumes are deposited. In addition, cooling of the brazing material 12 and the welded portions 16 before the laser irradiation can be effectively suppressed since supply of the gas thereto can be suppressed. Therefore, the workpieces 14 can be joined more efficiently and satisfactorily.

It should be noted that the present invention is not limited to the case where the gas injection direction Y is inclined with respect to the laser irradiation direction Z in the manner described above. The distance between the laser irradiation portion 44 and the gas injection target portion 46 changes according to, for example, the traveling speed of the laser beam along the brazing advancing direction. Therefore, for example, it is preferable to appropriately set the gas injection direction Y in accordance with the traveling speed of the laser beam.

For example, when the traveling speed of the laser beam decreases, the distance between the laser irradiation portion 44 and the gas injection target portion 46 tends to also decrease. Therefore, the gas injection mechanism 34 may reduce the inclination angle of the gas injection direction Y with respect to the laser irradiation direction Z. Further, the gas injection mechanism 34 may inject the gas toward the gas injection target portion 46 such that the gas injection direction Y is along the laser irradiation direction Z. These also make it possible to satisfactorily disperse spatters and fumes and keep them away from the melted brazing material 12.

When the gas injection direction Y is along the laser irradiation direction Z, the gas injection mechanism 34 injects the gas toward the gas injection target portion 46 from above the gas injection target portion 46 in the brazing advancing direction.

In the laser irradiation step of the brazing method according to the above-described embodiment, gas is injected from the gas injection port 50 disposed behind the laser irradiation port 42 in the brazing advancing direction. Further, in the brazing apparatus 10 according to the above-described embodiment, the gas injection port 50 of the gas injection mechanism 34 is disposed behind the laser irradiation port 42 of the laser irradiation mechanism 30 in the brazing advancing direction.

In these cases, since the gas injection port 50 can be brought close to the gas injection target portion 46, the gas can be efficiently injected to the gas injection target portion 46. Further, the inclination angle of the gas injection direction Y with respect to the laser irradiation direction Z can be easily decreased, and the gas injection direction Y can be easily made to lie along the laser irradiation direction Z.

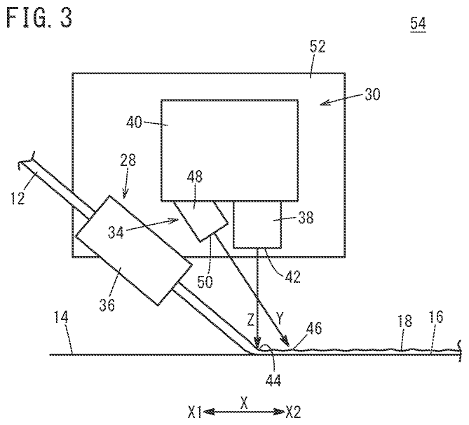

It should be noted that the gas injection port 50 is not limited to being disposed behind the laser irradiation port 42 in the brazing advancing direction. For example, as in a brazing apparatus 54 according to a modified example shown in FIG. 3, the injection nozzle 48 of the gas injection mechanism 34 may be held by the holding section 40 such that the injection port 50 thereof is disposed ahead of the irradiation port 42 of the irradiation nozzle 38 in the brazing advancing direction. In the case where the gas is injected toward the gas injection target portion 46 from the injection port 50 disposed ahead of the irradiation port 42 in this manner, the gas injection mechanism 34 injects the gas from the front side toward the rear side in the brazing advancing direction so that the gas injection direction Y is inclined with respect to the laser irradiation direction Z.

Since the injection port 50 is disposed ahead of the irradiation port 42 in this manner, even when the distance between the laser irradiation portion 44 and the gas injection target portion 46 is short, it is possible to easily increase the inclination angle of the gas injection direction Y with respect to the laser irradiation direction Z. This makes it possible to effectively form, on the workpieces 14, a gas flow from the front side to the rear side in the brazing advancing direction. As a result, it is possible to satisfactorily disperse the spatters and fumes so as to keep them away from the melted brazing material 12. In addition, cooling of the brazing material 12 and the welded portions 16 before the laser irradiation can be effectively suppressed since supply of the gas thereto can be suppressed.

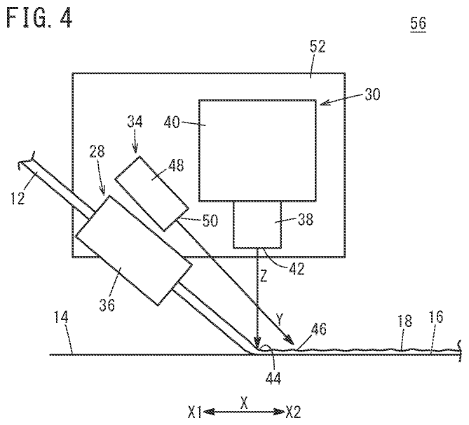

In the brazing apparatuses 10 and 54 shown in FIGS. 1 to 3, the injection nozzle 48 of the gas injection mechanism 34 is held by the holding section 40 of the laser irradiation mechanism 30. In this case, for example, the brazing apparatuses 10 and 54 can be easily miniaturized and simplified. However, the present invention is not limited to this configuration, and as in a brazing apparatus 56 according to a modified example shown in FIG. 4, for example, the injection nozzle 48 of the gas injection mechanism 34 may be supported by the support frame 52 of the transport mechanism 32 (see FIG. 1), separately from the laser irradiation mechanism 30.

In the brazing apparatus 56, for example, the injection nozzle 48 of the gas injection mechanism 34 is supported by the support frame 52 such that the injection port 50 thereof is disposed ahead of the irradiation port 42 of the irradiation nozzle 38 in the brazing advancing direction. Therefore, the gas injection mechanism 34 injects the gas from the front side of the gas injection target portion 46 in the brazing advancing direction. That is, the gas injection mechanism 34 injects the gas from the front side toward the rear side in the brazing advancing direction so that the gas injection direction Y is inclined with respect to the laser irradiation direction Z.

Further, although not shown, the injection nozzle 48 of the gas injection mechanism 34 may be supported by the support frame 52 separately from the laser irradiation mechanism 30 such that the injection port 50 thereof is disposed behind the irradiation port 42 of the irradiation nozzle 38 in the brazing advancing direction. In this case, the gas injection mechanism 34 may inject the gas toward the gas injection target portion 46 from above the gas injection target portion 46 in the brazing advancing direction. Further, the gas injection mechanism 34 may inject the gas toward the gas injection target portion 46 from the front side of the gas injection target portion 46 in the brazing advancing direction.

As described above, since the injection nozzle 48 of the gas injection mechanism 34 and the laser irradiation mechanism 30 are supported separately from each other, it is possible to improve the degree of freedom of the angle adjustment of the injection direction Y toward the gas injection target portion 46.

The present invention is not limited to the above-described embodiments, and various modifications can be made thereto without departing from the scope of the present invention.

### REFERENCE SIGNS LIST

10, 54 56: brazing apparatus
12: brazing material
14: workpiece
16: welded portion
18: weld bead
26: joined body
28: brazing material supply mechanism
30: laser irradiation mechanism
32: transport mechanism
34: gas injection mechanism
42: irradiation port
44: laser irradiation portion
46: gas injection target portion
50: injection port

1. A brazing method for joining workpieces together by forming a weld bead at welded portions of the workpieces by melting and then solidifying a brazing material, the brazing method comprising:
a brazing material supply step of supplying the brazing material to the welded portions; and
a laser irradiation step of irradiating the brazing material supplied to the welded portions with a laser beam while moving the laser beam along a brazing advancing direction to form the weld bead, wherein
in the laser irradiation step, gas is injected toward a gas injection target portion from above the gas injection target portion or from a front side of the gas injection target portion in the brazing advancing direction, the gas injection target portion being a portion including the weld bead located on a rear side, in the brazing advancing direction, of a laser irradiation portion of the brazing material that is irradiated with the laser beam.

2. The brazing method according to claim 1, wherein
in the laser irradiation step, the gas is injected from a front side toward a rear side in the brazing advancing direction in a manner that an injection direction of the gas is inclined with respect to an irradiation direction of the laser beam.

3. The brazing method according to claim 1, wherein
in the laser irradiation step, the gas is injected from an injection port for the gas, the injection port being disposed behind an irradiation port for the laser beam in the brazing advancing direction.

4. A brazing apparatus that joins workpieces together by forming a weld bead at welded portions of the workpieces by melting and then solidifying a brazing material, the brazing apparatus comprising:
a brazing material supply mechanism configured to supply the brazing material to the welded portions;
a laser irradiation mechanism configured to irradiate the brazing material supplied to the welded portions with a laser beam;
a transport mechanism configured to move the brazing material supply mechanism and the laser irradiation mechanism in a brazing advancing direction relative to the welded portions; and
a gas injection mechanism configured to inject gas toward a gas injection target portion from above the gas injection target portion or from a front side of the gas injection target portion in the brazing advancing direction, the gas injection target portion being a portion including the weld bead located on a rear side, in the brazing advancing direction, of a laser irradiation portion of the brazing material that is irradiated with the laser beam by the laser irradiation mechanism.

5. The brazing apparatus according to claim 4, wherein
the gas injection mechanism injects the gas from a front side toward a rear side in the brazing advancing direction in a manner that an injection direction of the gas is inclined with respect to an irradiation direction of the laser beam.

6. The brazing apparatus according to claim 4, wherein
the gas injection mechanism includes an injection port for the gas, the laser irradiation mechanism includes an irradiation port for the laser beam, and the injection port is disposed behind the irradiation port in the brazing advancing direction.
